(19) United States
(12) Patent Application Publication
(10) Pub. No.: US 2023/0169325 A1
(43) Pub. Date: Jun. 1, 2023

(54) LEARNING ENERGY-BASED MODEL WITH VARIATIONAL AUTO-ENCODER AS AMORTIZED SAMPLER

(71) Applicant: Baidu USA, LLC, Sunnyvale, CA (US)

(72) Inventors: Jianwen XIE, Santa Clara, CA (US); Zilong ZHENG, Beijing (CN); Ping LI, Bellevue, WA (US)

(73) Assignee: Baidu USA LLC, Sunnyvale, CA (US)

(21) Appl. No.: 17/538,635

(22) Filed: Nov. 30, 2021

(51) Int. Cl. G06N 3/08; G06F 30/27

(52) U.S. Cl. CPC G06N 3/08; G06F 30/27; G06F 2119/06

(57) ABSTRACT

Training energy-based models (EBMs) by maximum likelihood may require MCMC sampling to approximate the gradient of Kullback-Leibler divergence between data and model distributions, but it is non-trivial to sample from an EBM because of the difficulty of mixing between modes. The present disclosure discloses embodiments to learn a variational auto-encoder (VAE) to initialize a finite-step MCMC derived from an energy function for efficient amortized sampling of the EBM. With these amortized MCMC samples, the EBM may be trained by maximum likelihood, which follows an “analysis by synthesis” scheme; while the VAE learns from MCMC samples via variational Bayes. In this joint training process, the VAE chases the EBM toward data distribution. The learning methodology may be interpreted as a dynamic alternating projection in the context of information geometry. The disclosed model may generate samples comparable to GANs and EBMs, and learn effective probabilistic distribution toward supervised conditional learning tasks.

### BACKGROUND

### A. Technical Field

The present disclosure relates generally to systems and methods for computer learning that can provide improved computer performance, features, and uses. More particularly, the present disclosure relates to systems and methods to use variational auto-encoding for energy-based generative mode training.

### B. Background

Deep neural networks have achieved great successes in many domains, such as computer vision, natural language processing, recommender systems, etc. However, generative modeling of high-dimensional data is a very challenging and fundamental problem in both computer vision and machine learning communities. Energy-based generative models with the energy function parameterized by a deep neural network have been drawing attention in the recent literature, not only for their empirically powerful ability to learn highly complex probability distributions, but also for their theoretically fascinating aspects of representing high-dimensional data. Successful applications with energy-based generative frameworks have been witnessed in the field of computer vision, for example, video synthesis, three-dimensional (3D) volumetric shape synthesis, unordered point cloud synthesis, supervised image-to-image translation, and unpaired cross-domain visual translation. Other applications can be seen in natural language processing, biology, and inverse optimal control.

Due to the intractable partition function, training energy-based models (EBMs) by maximum likelihood requires Markov chain Monte Carlo (MCMC) sampling to approximate the gradient of the Kullback-Leibler (KL) divergence between data and model distributions. However, it is non-trivial to sample from an EBM because of the difficulty of mixing between modes.

Accordingly, what is needed are systems and methods to train EBMs with improved efficiency.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures may not be to scale.

Figure (“FIG.”) 1 depicts a process for ancestral Langevin sampling, according to embodiments of the present disclosure.

FIG. 2 depicts a process for EBM training via variational MCMC teaching, according to embodiments of the present disclosure.

FIG. 3 graphically depicts a high-level comparison among different types of MCMC teaching methodologies, according to embodiments of the present disclosure.

FIG. 4 depicts a process for variational MCMC teaching, according to embodiments of the present disclosure.

FIG. 5 depicts a process for conditional predictive learning, according to embodiments of the present disclosure.

FIG. 6 graphically depicts variational learning interpreted as a process of alternating projection between manifolds, according to embodiments of the present disclosure.

FIG. 7 graphically depicts energy-based learning interpreted as a process of manifold shifting, according to embodiments of the present disclosure.

FIG. 8 graphically depicts variational MCMC teaching as dynamic alternating projection, according to embodiments of the present disclosure.

FIG. 9 graphically depicts a convergent point of the dynamic alternating projection, according to embodiments of the present disclosure.

FIG. 10 depicts a simplified block diagram of a computing device/information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to a system component or components into which information may be entered or otherwise recorded. A set may contain any number of elements, including the empty set.

In one or more embodiments, a stop condition may include: (1) a set number of iterations have been performed; (2) an amount of processing time has been reached; (3) convergence (e.g., the difference between consecutive iterations is less than a threshold value); (4) divergence (e.g., the performance deteriorates); (5) an acceptable outcome has been reached; and (6) all of the data has been processed.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

### A. General Introduction

Generative modeling of high-dimensional data is a very challenging and fundamental problem in both computer vision and machine learning communities. An energy-based generative model with an energy function parameterized by a deep neural network has been drawing attention in the recent literature, not only for its empirically powerful ability to learn highly complex probability distribution, but also for its theoretically fascinating aspects of representing high-dimensional data. Successful applications with energy-based generative frameworks have been witnessed in the field of computer vision, for example, video synthesis, 3D volumetric shape synthesis, unordered point cloud synthesis, supervised image-to-image translation, and unpaired cross-domain visual translation. Other applications for energy-based generative frameworks may include natural language processing, biology, and inverse optimal control.

Energy-based generative models directly define an unnormalized probability density as an exponential of the negative energy function, where the energy function maps the input variable to an energy scalar. Training an energy-based model (EBM) from observed data corresponds to finding an energy function, where observed data are assigned lower energies than unobserved ones. Synthesizing new data from the energy-based probability density may be achieved by a gradient-based MCMC method, which is an implicit and iterative generation process to find low energy regions of the learned energy landscape. Therefore, energy-based generative models may unify the generation and learning processes in a single model.

A persisting challenge in training an EBM of high-dimensional data via maximum likelihood estimation (MLE) is the calculation of the normalizing constant or the partition function, which requires a computationally intractable integral. Therefore, an MCMC sampling procedure, such as the Langevin dynamics or Hamiltonian Monte Carlo, from the EBMs is typically used to approximate the gradient of the partition function during the model training. However, the MCMC is computationally expensive or even impractical, especially if the target distribution has multiple modes separated by highly low probability regions. In such a case, traversing modes becomes very difficult and unlikely because different MCMC chains easily get trapped by different local modes.

To tackle the above challenge, the present patent document discloses embodiments to train a directed latent variable model as an approximate sampler that generates samples by deterministic transformation of independent and identically distributed random samples drawn from a Gaussian distribution. Such an ancestral sampler may efficiently provide a good initial point of an iterative MCMC sampling of the EBM to avoid a long computation time to generate convergent samples. In one or more embodiments, the process of first running an ancestral sampling by a latent variable model and then revising the samples by a finite-step Langevin dynamics derived from an EBM is referred to as the Ancestral Langevin Sampling (ALS). ALS may take advantage of both Langevin sampling and ancestral sampling. First, because the ancestral sampler connects the low-dimensional Gaussian distribution with the high-dimensional data distribution, traversing modes of the data distribution become more tractable and practical by sampling from the low-dimensional latent space. Secondly, the Langevin sampler is an attractor-like dynamics that may refine the initial samples by attracting them to the local modes of the energy function, thus making the initially generated samples more stable and more likely configurations.

From the learning perspective, by comparing the difference between the observed examples and the ALS examples, the EBM may find its way to shift its density toward the data distribution via MLE. The ALS with a small number of Langevin steps may accelerate the training of the EBM in terms of convergence speed. To approximate the Langevin sampler and serve as a good MCMC initializer, the latent variable model may learn from the evolving EBM by treating the ALS examples at each iteration as training data. In one or more embodiments, the variational Bayes may be used to train the latent variable model by recruiting an approximate but computationally efficient inference model, which is typically an encoder network. Specifically, after the EBM revises the initial examples provided by the latent variable model, the inference model infers the latent variables of the revised examples, and then the latent variable model updates its mapping function by regressing the revised examples on their corresponding inferred latent codes. In one or more embodiments, the inference model and the latent variable model may form a modified variational auto-encoder (VAE) that learns from evolving ALS samples, which may be MCMC samples from the EBMs. In such a framework, the EBM provides infinite batches of fresh MCMC examples as training data to the VAE model. The learning of the VAE is affected by the EBM. While providing help to the EBM in sampling, the VAE learns to chase the EBM, which runs towards the data distribution with the efficient sampling ALS. Within the VAE, the inference model and the posterior of the latent variable model get close to each other via maximizing the variational lower bound of the log-likelihood of the ALS samples. In other words, the latent variable model may be trained with both variational inference of the inference model and MCMC teaching of the EBM. In one or more embodiments, this training process may be referred to as Variational MCMC teaching.

Moreover, the generative framework may be easily generalized to the conditional model by involving a conditional EBM and a conditional VAE, for representing a distribution of structured output given another structured input. This conditional model may be very useful and be applied to plenty of computer vision tasks, such as image inpainting, etc.

In summary, contributions of the present patent disclosure include at least the following:

(1) Embodiments of a new framework are presented to train energy-based models (EBMs) as an amortized sampler, where a VAE is jointly trained via MCMC teaching to fast initialize the Langevin dynamics of the EBM for its maximum likelihood learning. The amortized sampler may be referred to as an ancestral Langevin sampler in one or more embodiments.

(2) Embodiments of a new strategy, referred to as variational MCMC teaching, are presented to train latent variable model, where an EBM and an inference model are simultaneously trained to provide infinite training examples and efficiently approximate inference for the latent variable model, respectively.

(3) In one or more embodiments, the maximum likelihood learning, variational inference, and MCMC teaching are naturally unified in a single framework to induce maximum likelihood learning of all the probability models.

(4) An information geometric understanding of a joint training methodology is presented. The joint training methodology may be interpreted as a dynamic alternating projection.

(5) Strong empirical results are provided on unconditional image modeling and conditional predictive learning to corroborate the presented method.

### B. Some Related Work

There are three types of interactions involved in one or more embodiments of the present patent disclosure. The inference model and the latent variable model are trained in a variational inference scheme, the EBM and the latent variable model are trained in a cooperative learning scheme, and the EBM and the data distribution form an MCMC-based maximum likelihood estimation or “analysis by synthesis” learning scheme.

Energy-based density estimation. The maximum likelihood estimation of the energy-based model follows an “analysis by synthesis” scheme. At each iteration, the computation of the gradient of the log-likelihood requires MCMC sampling, such as the Gibbs sampling or Langevin dynamics. To overcome the computational hurdle of MCMC, the contrastive divergence, which is an approximate maximum likelihood, initializes the MCMC with training data in learning the EBM. The noise-contrastive estimation of the EBM turns a generative learning problem into a discriminative learning one by performing nonlinear logistic regression to discriminate the observed examples from some artificially generated noise examples. Some proposed to learn EBM with non-convergent non-persistent short-run MCMC as a flow-based generator, which may be useful for synthesis and reconstruction. In one or more embodiments of the present patent disclosure, the training of the EBM in the presented framework may follow the “analysis by synthesis”, except that the synthesis is performed by the ancestral Langevin sampling instead.

Training an EBM jointly with a complementary model. To avoid MCMC sampling of the EBM, some approximated it by a latent variable model trained by minimizing the KL divergence from the latent variable model to the EBM. It involves an intractable entropy term, which is problematic if it is ignored. The gap between the latent variable model and the EBM due to their imbalanced model design may still cause bias or model collapse in training. In one or more embodiments of the present patent disclosure, the gap may be bridged by taking back the MCMC to serve as an attractor-like dynamics to refine any imperfection of the latent variable model in the learned VAE. In comparison with previous work of either using another MCMC to compute the intractable posterior of the latent variable model or directly ignoring the inference step for approximation, a tractable variational inference model is learned for training the latent variable model in one or more embodiments of the present patent disclosure.

### C. Preliminary

In this section, some preliminary information of EBMs and VAEs are presented to serve as foundations of the framework in the present patent disclosure.

### 1. EBM and Analysis by Synthesis

Let x∈ [symbol] be the high-dimensional random variable, such as an input image. An EBM (also called Markov random field, Gibbs distribution, or exponential family model), with an energy function U_{θ}(x) and a set of trainable parameters θ, learns to associate a scalar energy value to each configuration of the random variable, such that more plausible configurations (e.g., observed training images) are assigned lower energy values. Formally, an EBM may be defined as a probability density with the following form:

$${p}_{θ} ( x ) = \frac{1}{Z ( θ )} exp [ - {U}_{θ} ( x ) ]$$

In Equation (1), Z(θ)=∫exp[−U_{θ}(x)] dx is a normalizing constant or a partition function depending on θ, and is analytically intractable to calculate due to high dimensionality of x. In one or more embodiments, U_{θ}(x) may be parameterized by a bottom-up convolutional neural network (e.g., ConvNet) with trainable weights θ and scalar output. In one or more embodiments, a bottom-up neural network may be referred to as a neural network receiving data, e.g., images, at the bottom and generating an output, e.g., latent variables or features, on top.

Assume a training dataset [symbol] ={xᵢ, i=1, . . . , n} is given and each data point is sampled from an unknown distribution p_{data}(x), in order to use the EBM p_{θ}(x) to estimate the data distribution p_{data}(x), the negative log-likelihood (NLL) of the observed data

$$L ( θ ; 𝒟 ) = - \frac{1}{n} {\sum }_{i = 1}^{n} log {p}_{θ} ( {x}_{i} ) ,$$

or equivalently the KL-divergence between the two distributions KL(p_{data}(x)∥p_{θ}(x)) may be minimized by gradient-based optimization methods. The gradient to update parameters θ may be computed by the following formula:

$$\frac{\partial }{\partial θ} KL ( {p}_{data} ( x ) \vert \vert {p}_{θ} ( x ) ) = {E}_{x ∼ {p}_{data} ( x )} [ \frac{\partial {U}_{θ} ( x )}{\partial θ} ] - {E}_{\tilde{x} ∼ {p}_{θ} ( x )} [ \frac{\partial {U}_{θ} ( \tilde{x} )}{\partial θ} ] \qquad ( 2 )$$

In one or more embodiments, the two expectations in Equation (2) may be approximated by averaging over the observed examples {xᵢ} and the synthesized examples {\tilde{x}ᵢ} that are sampled from the model p_{θ}(x), respectively. This may lead to an “analysis by synthesis” methodology that iterates a synthesis step for image sampling and an analysis step for parameter learning.

Drawing samples from EBMs typically requires Markov chain Monte Carlo (MCMC) methods. If the data distribution p_{data}(x) is complex and multimodal, the MCMC sampling from the learned model is challenging because it may take a long time to mix between modes. Thus, the ability to generate efficient and fair examples from the model becomes the key to training successful EBMs. In the present patent disclosure, amortized sampling embodiments are presented for efficient training of the EBMs.

### 2. Latent Variable Model and Variational Inference

Consider a directed latent variable model of the form:

z˜ [symbol] (0,I_{d}),x=g_{α}(z)+ϵ,ϵ˜ [symbol] (0,σ²I_{D}) (3)

In Equation (3), z∈ [symbol] is a d-dimensional vector of latent variables following a Gaussian distribution [symbol] (0, I_{d}), I_{d} is a d-dimensional identity matrix, g_{α} is a nonlinear mapping function parameterized by the latent variable model q_{α} with trainable parameters α, and ϵ∈ [symbol] is the residual noise that is independent of z. In one or more embodiments, the latent variable model q_{α} is a top-down deep neural network.

The marginal distribution of the model in Equation (3) is q_{α}(x)=∫q_{α}(x|z)q(z)dz, where the prior distribution q(z)= [symbol] (0, I_{d}) and the conditional distribution of x given z is q_{α}(x|z)= [symbol] (g_{α}(z), σ²I_{D}). The posterior distribution is q_{α}(z|x)=q(z, x)/q_{α}(x)=q_{α}(x|z)q(z)/q_{α}(x). Both posterior distribution q_{α}(z|x) and marginal distribution q_{α}(x) are analytically intractable. The model may be learned by maximum likelihood estimation or equivalently minimizing the KL-divergence KL(p_{data}(x)∥q_{α}(x)), whose gradient may be given by:

$$\frac{\partial }{\partial α} KL ( {p}_{data} ( x ) \vert \vert {q}_{α} ( x ) ) = {E}_{{p}_{data} ( x ) {q}_{α} ( Z \vert X )} [ - \frac{\partial }{\partial α} log {q}_{α} ( z , x ) ] \qquad ( 4 )$$

In one or more embodiments, MCMC methods may be used to compute the gradient in Equation (4). For each data point xᵢ sampled from the data distribution, the corresponding latent variable zᵢ may be inferred by drawing samples from q_{α}(z|x) via MCMC methods, then the expectation term may be approximated by averaging over the sampled pairs {xᵢ, zᵢ}. However, MCMC sampling of the posterior distribution may also take a long time to converge. To avoid MCMC sampling from q_{α}(z|x), a VAE may be used to approximate q_{α}(z|x) by a tractable inference network or an encoder, e.g., a multivariate Gaussian with a diagonal covariance structure π_{β}(z|x)˜ [symbol] (μ_{β}(x), diag(v_{β}(x))), where both μ_{β}(x) and v_{β}(x) are d-dimensional outputs of encoding bottom-up networks of data point x, with trainable parameters. With this reparameterization process, the objective of VAE becomes finding α and β to minimize the following equation:

KL(p_{data}(x)π_{β}(z|x)∥q_{α}(z,x))=KL(p_{data}(x)∥q_{α}(x))+KL(π_{β}(z|x)∥q_{α}(z|x)) (5)

Equation (5) is a modification of the maximum likelihood estimation objective. Minimizing the left-hand side in Equation (5) also leads to a minimization of the first KL-divergence on the right-hand side, which is the maximum likelihood estimation objective in Equation (4). In the present patent disclosure, embodiments to learn a latent variable model in the context of VAE are presented as an amortized sampler to train the EBM.

### D. Embodiments to Learn an EBM Via MLE with a VAE

In this section, embodiments to learn an EBM via MLE with a VAE as an amortized sampler are presented. The amortized sampler may be achieved by integrating the latent variable model (the generator network in VAE) and the short-run MCMC of the EBM. In one or more embodiments, the EBM and the VAE may be jointly trained via variational MCMC teaching.

### 1. Embodiments of Ancestral Langevin Sampling

To learn the energy-based generative model in Equation (1) and compute the gradient in Equation (2), a directed latent variable model q_{α}(x) is introduced to serve as a fast non-iterative sampler to initialize the iterative MCMC sampler guided by the energy function U_{θ}, for the sake of efficient MCMC convergence and mode traversal of the EBM. In one or more embodiments of the present patent disclosure, the resulting amortized sampler is referred to as the ancestral Langevin sampler. FIG. 1 depicts a process for ancestral Langevin sampling, according to embodiments of the present disclosure. An initial example \hat{x} is first sampled (105) via ancestral sampling, and then the initial example \hat{x} is revised (110) with a finite-step Langevin update, that is:

$$( i ) \hat{x} = {g}_{α} ( \hat{z} ) , \hat{z} ∼ 𝒩 ( 0 , {I}_{d} ) , \\ ( ii ) {\tilde{x}}_{t + 1} = {\tilde{x}}_{t} - \frac{{δ}^{2}}{2} \frac{\partial {U}_{θ} ( {\tilde{x}}_{t} )}{\partial \tilde{x}} + δ𝒩 ( 0 , {I}_{d} ) , {\tilde{x}}_{0} = \hat{x} , \qquad ( 6 )$$

In Equation (6), \hat{x} is the initial example generated by ancestral sampling using a direct latent variable model g_{α}, which serve as fast non-iterative samples to initialize MCMC sampling. \tilde{x} is the example generated by Langevin dynamics, t indexes the Langevin time step, and δ is the step size. In one or more embodiments, the Langevin dynamics may be equivalent to a stochastic gradient descent algorithm that seeks to find the minimum of the objective function defined by U_{θ}(x). In one or more embodiments, ancestral sampling may be referred to as a process of producing samples from a probabilistic model by first sampling variables having no parents using their prior distributions, then sampling their child variables conditioned on these sampled values, and so on.

In the original “analysis by synthesis” methodology, the Langevin dynamics shown in Equation (6)(ii) may be initialized with a noise distribution, such as Gaussian distribution, i.e., \tilde{x}₀˜ [symbol] (0, I_{d}), and this usually takes a long time to converge and may also be non-stable in practice because the gradient-based MCMC chains may get trapped in the local modes when exploring the model distribution.

As to the ancestral Langevin sampling in Equation (6), if the latent variable model in Equation (6)(i) may memorize the majority of the modes in p_{θ}(x) by low dimensional codes \hat{z}, modes of the model distribution may be traversed by simply sampling from p(\hat{z})= [symbol] (0, I_{d}), because p(\hat{z}) is much smoother than p_{θ}(x). The short-run Langevin dynamics initialized with the output \hat{x} of the latent variable model emphasizes on refining the detail of \hat{x} by further searching for a better mode \tilde{x} around \hat{x}. Ideally, if p_{θ}(x) and q_{α} (x) fit the data distribution p_{data}(x) perfectly, the example \hat{x} produced by the ancestral sampling will be exactly on the modes of U_{θ}(x). In this idea case, the following Langevin revision does not change the \hat{x}, i.e., \tilde{x}=\hat{x}. Otherwise, the Langevin update further improves \hat{x}.

### 2. Embodiments of Variational MCMC Teaching

In one or more embodiments, With {\tilde{x}ᵢ}ᵢ₌₁^{ñ}˜p_{θ}(x) via ancestral Langevin sampling in Equation (6), the gradient in Equation (2) may be obtained by:

$$\frac{\partial }{\partial θ} KL ( {P}_{data} ( x ) \vert \vert {p}_{θ} ( x ) ) \approx \frac{1}{n} {\sum }_{i = 1}^{n} \frac{\partial {U}_{θ} ( {x}_{i} )}{\partial θ} - \frac{1}{\tilde{n}} {\sum }_{i = 1}^{\tilde{n}} \frac{\partial {U}_{θ} ( {\tilde{x}}_{i} )}{\partial θ} \qquad ( 7 )$$

Afterwards, θ may be updated using an optimization methodology, e.g., Adam optimization, for EBM training. Consider in this iterative approach, the current model parameter θ and α are θₜ and αₜ respectively. [symbol] _{θ}_{ₜ} is used to denote the Markov transition kernel of a finite-step Langevin dynamics that samples from the current distribution p_{θ}_{ₜ}(x). [symbol] _{θ}_{ₜ}q_{α}_{ₜ}(x)=∫ [symbol] _{θ}_{ₜ}(x′, x)q_{α}_{ₜ}(x′)dx′ is also used to denote the marginal distribution obtained by running [symbol] _{θ}_{ₜ} initialized from current q_{α}_{ₜ}(x). In one or more embodiments, the MCMC-based MLE training of θ seeks to minimize the following objective at each iteration:

$${θ}_{t + 1} = {argmin}_{θ} [ KL ( {p}_{data} ( x ) \vert \vert {p}_{θ} ( x ) ) - KL ( {ℳ}_{{θ}_{t}} {q}_{{α}_{t}} ( x ) \vert \vert {p}_{θ} ( x ) ) ] , \qquad ( 8 )$$

In one or more embodiments, Equation (8) may be considered as a modified contrastive divergence. Meanwhile, q_{α}_{ₜ₊₁}(x) is learned based on how the finite steps of Langevin [symbol] _{θ}, revises the initial example {\tilde{x}ᵢ} generated by q_{α}_{ₜ}(x) to mimic the Langevin sampling. This is the energy-based MCMC teaching of q_{α}(x).

Although q_{α}(x) initializes the Langevin sampling of {\tilde{x}ᵢ}, the corresponding latent variables of {\tilde{x}ᵢ} are no longer {\hat{z}ᵢ}. In one or more embodiments of the present disclosure, to retrieve the latent variables of {\tilde{x}ᵢ}, \tilde{z} may be inferred by \tilde{z}˜π_{β}(z|\tilde{x}), which is an approximate tractable inference network (or an encoder), and then α may be learned from complete data {\tilde{z}ᵢ, \tilde{x}ᵢ}ᵢ₌₁^{ñ} to minimize Σᵢ∥\tilde{x}ᵢ−g_{α}(\tilde{z}ᵢ)∥² (or equivalently maximize Σᵢ log q_{α}(\tilde{z}ᵢ, \tilde{x}ᵢ)). In one or more embodiments of the present disclosure, to ensure π_{β}(z|\tilde{x}) to be an effective inference network that mimics the computation of the true inference procedure \tilde{z}˜q_{α}(z|x), β may be simultaneously learned by minimizing KL(π_{β}(z|x)∥q_{α}((z|x))), i.e., a reparameterization process of the variational inference of q_{α}(x).

In one or more embodiments, the learning of π_{β}(z|x) and q_{α}(x|z) may form a VAE that treats {\tilde{x}ᵢ} as training examples. Because {\tilde{x}ᵢ} are dependent on θ and vary during training, the objective function of the VAE is non-static. This is essentially different from the original VAE that has fixed training data. Supposing {\tilde{x}ᵢ}ᵢ₌₁^{ñ}˜ [symbol] _{θ}_{ₜ}q_{α}_{ₜ}(x) at the current iteration t, the VAE objective in one or more embodiments of the presented framework may be a minimization of variational lower bound of the negative log-likelihood of {\tilde{x}ᵢ}ᵢ₌₁^{ñ}, i.e.,

$$L ( α , β ) = {\sum }_{i = 1}^{\tilde{n}} [ - log {q}_{α} ( {\tilde{x}}_{i} ) + γ KL ( {π}_{β} ( {z}_{i} \vert {\tilde{x}}_{i} ) \vert \vert {q}_{α} ( {z}_{i} \vert {\tilde{x}}_{i} ) ) ] \qquad ( 9 )$$

In Equation (9), γ is a hyper-parameter that specifies the importance of the KL divergence term. Since when ñ→∞,

$${min}_{α} {\sum }_{i = 1}^{\tilde{n}} [ - log {q}_{α} ( {\tilde{x}}_{i} ) ] = {min}_{α} KL ( {ℳ}_{{θ}_{t}} {q}_{{α}_{t}} ( x ) \vert \vert {q}_{α} ( x ) )$$

In one or more embodiments, Equation (9) may be equivalent to minimizing:

KL( [symbol] _{θ}_{ₜ}q_{α}_{ₜ}(x)∥q_{α}(x))+KL(π_{β}(z|x)|q_{α}(z|x))=KL( [symbol] _{θ}_{ₜ}q_{α}_{ₜ}(x)π_{β}(z|x)∥q_{α}(z|x)q(z)) (10)

Unlike the objective function of the maximum likelihood estimation KL( [symbol] _{θ}_{ₜ}q_{α}_{ₜ}(x)∥q_{α}(x)), which involves the intractable marginal distribution q_{α}(x), the variational objective function is the KL divergence between the joint distributions, which is tractable because π_{β}(z|x) parameterized by an encoder is tractable. In comparison with the original VAE objective in Equation (5), the presented VAE objective in Equation (10) replaces p_{data}(x) by [symbol] _{θ}_{ₜ}q_{α}_{ₜ}(x). At each iteration, minimizing the variational objective in Equation (10) decreases KL( [symbol] _{θ}_{ₜ}q_{α}_{ₜ}(x)∥q_{α}(x)). Since q_{α}_{ₜ}(x) is learned in the context of both MCMC teaching and variational inference, this joint training process is referred to as the variational MCMC teaching in one or more embodiments of the present patent disclosure. Methodology 1 below describes a joint training methodology of EBM and VAE, according to embodiments of the present disclosure.

Methodology 1 Cooperative training of EBM
and VAE via variational MCMC teaching

Input: (a) training images {xᵢ}ᵢ₌₁ⁿ , (b) number of Langevin steps l
Output: (a) model parameters {θ, α, β}, (b) initial samples {\hat{x}ᵢ}ᵢ₌₁^{ñ}, (c) Langevin samples

| | {\tilde{x}ᵢ}ᵢ₌₁^{ñ} |
|---|---|
| 1: | Let t ← 0, randomly initialize θ, α, and β. |
| 2. | repeat |
| 3. | ancestral Langevin sampling: For i = 1,...,ñ, sample \hat{z}ᵢ ~ [symbol] (0, I_{d}), then generate |
| | \hat{x}ᵢ = g_{α}(\hat{z}ᵢ), and run l steps of Langevin revision starting from \hat{x}ᵢ to obtain \tilde{x}ᵢ, each step |
| | following Eq. (6)(ii). |
| 4. | modified contrastive divergence: Treat {\tilde{x}ᵢ}ᵢ^{ñ} as MCMC examples from p_{θ}(x), and |
| | update θ by Adam with the gradient computed according to Equation (7). |
| 5. | variational MCMC teaching: Treat {\tilde{x}ᵢ}ᵢ^{ñ} as training data, update α and β by |
| | minimizing VAE objective in Equation (9) via Adam. |
| 6. | Let t ← t + 1 |
| 7. | until t = T |

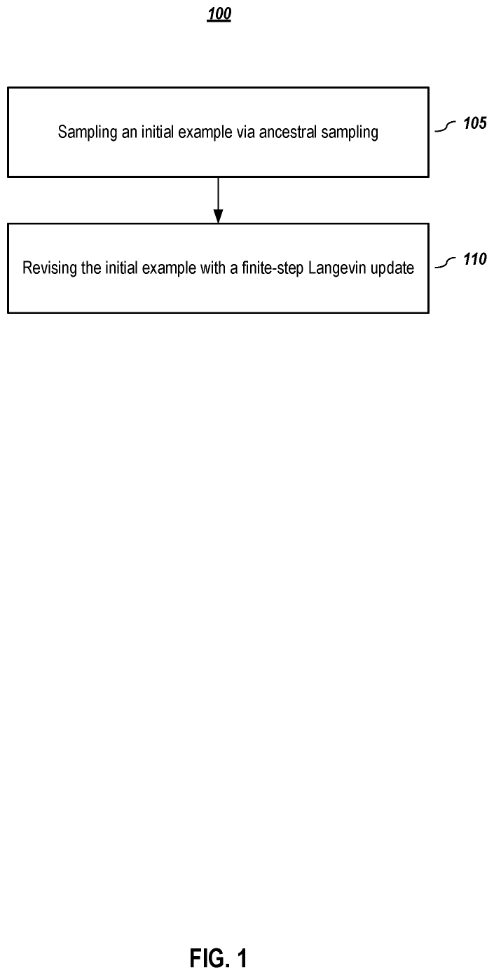

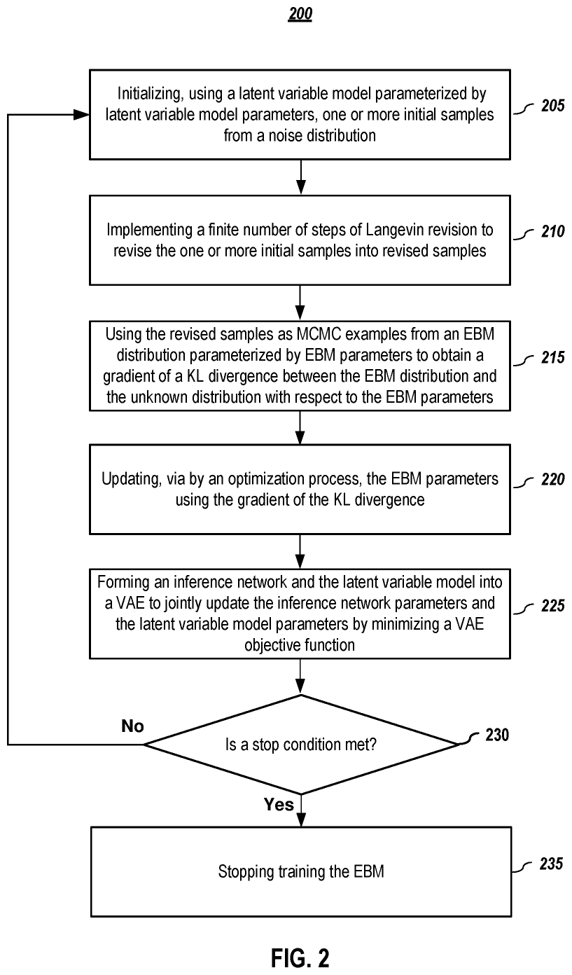

FIG. 2 depicts a process for EBM training via variational MCMC teaching given a training dataset {xᵢ}ᵢ₌₁ⁿ sampled from an unknown distribution p_{data}(x), according to embodiments of the present disclosure. One or more initial samples {\hat{x}ᵢ}ᵢ₌₁^{ñ} are initialized (205) from a noise distribution \hat{z}ᵢ˜ [symbol] (0, I_{d}) using a latent variable model g_{α} parameterized by latent variable model parameters α, which is trainable. In one or more embodiments, the noise distribution may be a Gaussian distribution. A finite-step Langevin revision is implemented (210) to revise the one or more initial samples {\hat{x}ᵢ}ᵢ₌₁^{ñ} into revised samples {\tilde{x}ᵢ}ᵢ^{ñ}. In one or more embodiments, the Langevin revision may be driven by the EBM parameterized by EBM parameters, which is the Langevin progress need to use the EBM parameters. The revised samples {\tilde{x}ᵢ}ᵢ^{ñ} are used as MCMC examples from an EBM distribution p_{θ}(x) parameterized by EBM parameters θ to obtain (215) a gradient of a KL divergence KL(p_{data}(x)∥p_{θ}(x)) between the EBM distribution p_{θ}(x) and the unknown distribution p_{data}(x) with respect to the EBM parameters θ. In one or more embodiments, the KL divergence may be approximated, as shown in Equation (7), as a difference between an average gradient

$$( \frac{1}{n} {\sum }_{i = 1}^{n} \frac{\partial {U}_{θ} ( {x}_{i} )}{\partial θ} )$$

of an EBM energy function U_{θ} of the training dataset {xᵢ}ᵢ₌₁ⁿ with respect to EBM parameters θ and an average gradient

$$( \frac{1}{\tilde{n}} {\sum }_{i = 1}^{\tilde{n}} \frac{\partial {U}_{θ} ( {\tilde{x}}_{i} )}{\partial θ} )$$

of an EBM energy function U_{θ} of the revised samples {\tilde{x}ᵢ}ᵢ₌₁^{ñ} with respect to EBM parameters θ. The EBM parameters θ are updated (220) via an optimization process, e.g., Adam optimization, using the gradient of the KL divergence. In one or more embodiments, the optimization for updating the EBM parameters θ involves minimizing a modified contrastive divergence, which is a difference between the KL divergence KL(p_{data}(x)∥p_{θ}(x)) and a KL divergence between a marginal distribution [symbol] _{θ}_{ₜ}q_{α}_{ₜ}(x) and the EBM distribution p_{θ}(x), as shown in Equation (8). An inference network π_{β}, parameterized by inference network parameters β, and the latent variable model g_{α} form (225) into a VAE to jointly update the inference network parameters β and the latent variable model parameters α by minimizing a VAE objective function. In one or more embodiments, the inference network π_{β} functions as an encoder and the latent variable model g_{α} functions as a decoder or a generator in the VAE. The revised samples {\tilde{x}ᵢ}ᵢ^{ñ} are used as training data to train the VAE.

In one or more embodiments, the steps in FIG. 2 are iterated (230) until a stop condition is met. The stop condition may be a predetermined iteration number, a convergence of at least one of the EBM parameters θ, the inference network parameters β, and the latent variable model parameters α. Once the stop condition is met, the training process for the EBM is stopped (235) and a trained EBM is obtained.

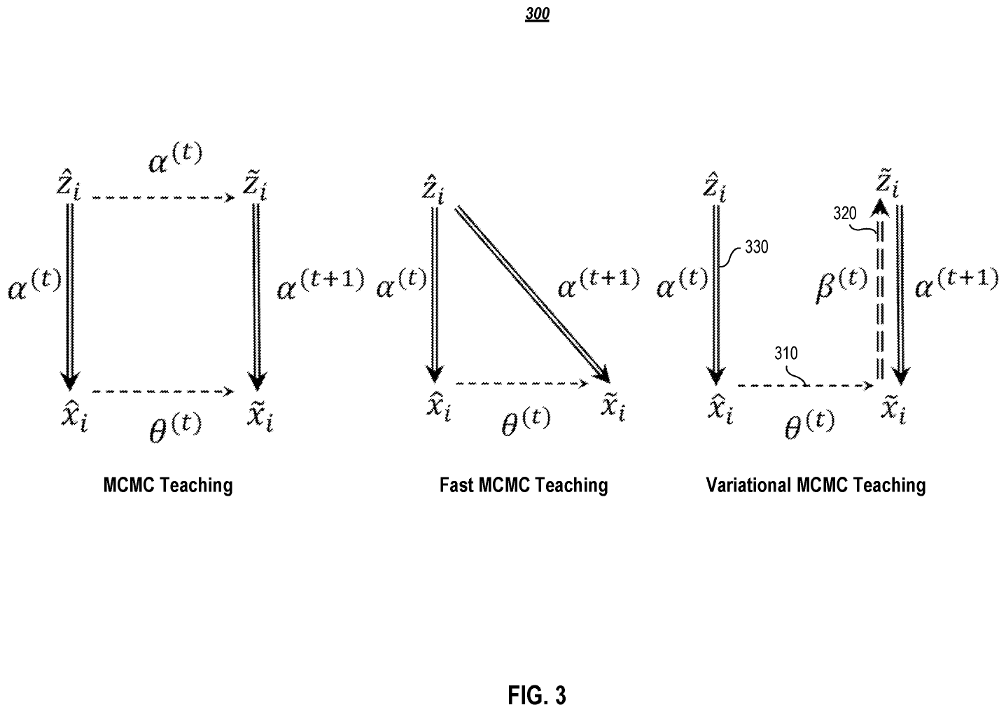

FIG. 3 graphically depicts a high-level comparison among different types of MCMC teachings: original MCMC teaching with an MCMC-based inference process, fast MCMC teaching without an inference step, and variational MCMC teaching. The double-solid-line arrows indicate generation and reconstruction by the latent variable model with parameters α. The dashed-line arrows indicate Langevin dynamics guided by θ in the latent space or data space. The double-dashed-line arrow indicates inference and encoding by the inference model with β. The presented variational MCMC teaching involves three models, an energy-based model 310, an inference model 320, and a latent variable model 330, and adopts a reparameterization process for inference, which is different from the original MCMC teaching and the fast MCMC teaching. Furthermore, the inference model 320 and the latent variable model 330 form a VAE for joint updating using a tractable variational objective function, which is KL-divergence between joint distributions. Such a tractable variational objective function is quite distinct from the objective function of the maximum likelihood estimation, which involves the intractable marginal distribution q_{α}(x).

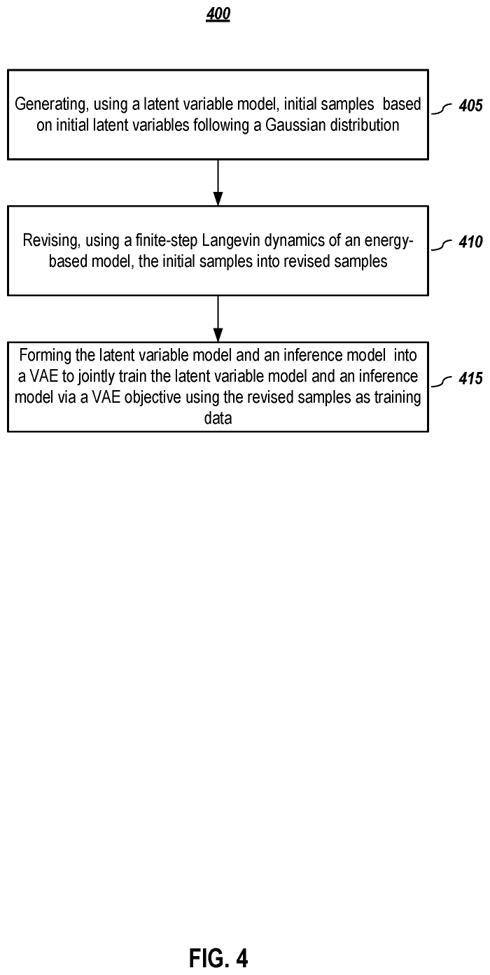

FIG. 4 depicts a process for variational MCMC teaching, according to embodiments of the present disclosure. Given initial latent variables \hat{z}ᵢ following a Gaussian distribution [symbol] (0, I_{d}), a latent variable model generates (405) initial samples \hat{x}ᵢ based on the latent variables \hat{z}ᵢ. The initial samples \hat{x}ᵢ are revised (410), using a finite-step Langevin dynamics of an energy-based model, into revised samples \tilde{x}ᵢ. The latent variable model and an inference model are formed into a VAE to jointly train (415) the latent variable model and an inference model via a VAE objective using the revised samples \tilde{x}ᵢ as training data. In one or more embodiments, the VAE objective is the minimization of variational lower bound of the negative log-likelihood of the revised samples \tilde{x}ᵢ.

### 3. Embodiments of Optimality of the Solution

This subsection presents a theoretical understanding of the framework presented in Section D. A Nash equilibrium of the model is a triplet (\hat{θ}; \hat{α}; \hat{β}) that satisfies:

\hat{θ}=arg min_{θ}[KL(p_{data}(x)∥p_{θ}(x))−KL( [symbol] _{\hat{θ}}q_{\hat{α}}(x)∥p_{θ}(x))] (11)

\hat{α}=arg min_{α}[KL( [symbol] _{\hat{θ}}q_{\hat{α}}(x)∥q_{α}(x))+KL(π_{\hat{β}}(z|x)∥q_{α}(z|x))] (12)

\hat{β}=arg min_{β}[KL(π_{β}(z|x)∥q_{\hat{α}}(z|x))] (13)

The description below shows that if (\hat{θ}; \hat{α}; \hat{β}) is a Nash equilibrium of the model, then p_{\hat{θ}}=q_{\hat{α}}=p_{data}.

In Equations (12) and (13), the tractable encoder π_{\hat{β}}(z|x) seeks to approximate the analytically intractable posterior distribution q_{\hat{α}}(z|x) via a joint minimization. When KL(π_{\hat{β}}(z|x)∥q_{\hat{α}}(z|x))=0, the second KL divergence term in Equation (12) vanishes, thus reducing Equation (12) to mina KL( [symbol] _{\hat{θ}}q_{\hat{α}}(x)∥q_{α}(x)), which means that q_{\hat{α}} seeks to be a stationary distribution of [symbol] _{\hat{θ}}, which is p_{\hat{θ}}. Therefore, when min_{α}KL( [symbol] _{\hat{θ}}q_{\hat{α}}(x)∥q_{α}(x))=0, [symbol] _{\hat{θ}}q_{\hat{α}}(x)=q_{\hat{α}}(z|x), q_{\hat{α}} converges to the stationary distribution p_{\hat{θ}}, and thus q_{\hat{α}}(x)=p_{\hat{θ}}(x). As a result, the second KL divergence in Equation (11) vanishes because KL( [symbol] _{\hat{θ}}q_{\hat{α}}(x)∥p_{\hat{θ}}(x))=KL( [symbol] _{\hat{θ}}p_{\hat{θ}}(x)∥p_{\hat{θ}}(x))=0. Equation (11) is eventually reduced to minimizing the first KL divergence KL(p_{data}(x)∥p_{θ}(x)) and thus p_{\hat{θ}}(x)=p_{data}(x). The overall effect of the methodology is that the EBM p_{θ} runs toward the data distribution p_{data} while inducing the latent variable model q_{α} to get close to the data distribution p_{data} as well, because q_{α} chases p_{θ} toward p_{data}, i.e., q_{α}→p_{θ}→p_{data}, thus q_{â}=p_{\hat{θ}}=p_{data}. In other words, the joint training methodology may lead to MLE of q_{α} and p_{θ}.

### 4. Embodiments of Conditional Predictive Learning

In one or more embodiments, the presented framework may be generalized to supervised learning of the conditional distribution of an output x given an input y, where both input and output are high-dimensional structured variables and may belong to two different modalities. In one or more embodiments, the presented framework may be generalized by turning both the EBM and the latent variable model into conditional ones.

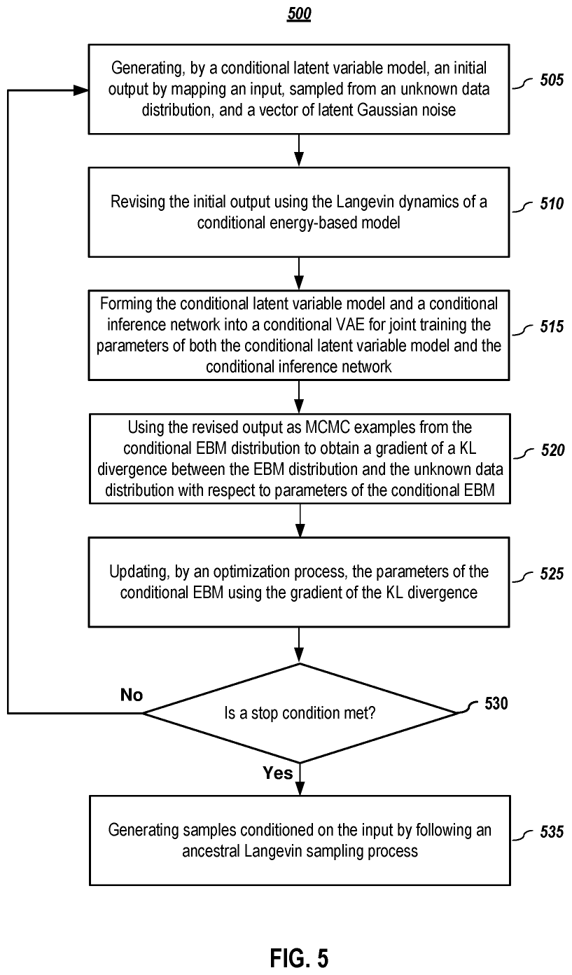

FIG. 5 depicts a process for conditional predictive learning, according to embodiments of the present disclosure. A conditional latent variable model q_{α}(x|y, z) generates (505) an initial output by mapping an input, sampled from an unknown data distribution, and a vector of latent Gaussian noise. The initial output is revised (510) using a Langevin dynamics of a conditional energy-based model (EBM) p_{θ}(x|y), which represents a conditional EBM distribution of an output x given an input y by using a joint energy function U_{θ}(x, y) of the conditional EBM. The conditional latent variable model and a conditional inference network π_{β}(z|y, x) form (515) into a conditional VAE for joint training the parameters of both the conditional latent variable model and the conditional inference network. The revised output is used (520) as MCMC examples from the conditional EBM distribution to obtain a gradient of a KL divergence between the EBM distribution and the unknown data distribution with respect to the EBM parameters. The EBM parameters are updated (525) via an optimization process using the gradient of the KL divergence. In one or more embodiments, the steps in FIG. 5 are iterated (530) until a stop condition, e.g., a predetermined iteration number, is met. Once a stop condition is met with the conditional latent variable model and the conditional inference network trained, samples {\tilde{x}ᵢ} conditioned on the input y may be generated (535) by following an ancestral Langevin sampling process.

In one or more embodiments, the conditional latent variable model q_{α}(x|y, z) generates an output x by mapping the input y and a vector of latent Gaussian noise variables z together via a mapping function x=g_{α}(y, z) and a conditional inference network π_{β}(z|y, x)˜ [symbol] (μ_{β}(x, y), v_{β}(x, y)), where the mapping function g_{α} is parameterized by latent variable model parameters α, μ_{β}(x, y) and v_{β}(x, y) are outputs of an encoder network taking x and y as inputs. The conditional latent variable model q_{α}(x|y, z) and the conditional inference network π_{β}(z|x, y) form into a conditional VAE for joint training, where the conditional inference network functions as an encoder and the conditional latent variable model functions as a decoder. Both the latent variable z in the latent variable model and the Langevin dynamics in the EBM allow for randomness in such a conditional mapping, thus making the presented model suitable for representing one-to-many mapping. Once the conditional latent variable model and the conditional inference network are trained, samples {\tilde{x}ᵢ} conditioned on the input y may be generated by following an ancestral Langevin sampling process. In one or more embodiments, to use the model on prediction tasks, a deterministic generation may be performed as prediction without sampling. For example, the conditional latent variable model may first generate an initial prediction via z*=E(z), \tilde{x}ᵢ=g_{α}(yᵢ, z*), and then the conditional EBM may refine \hat{x} by finite steps of noise-disable Langevin dynamics with

$${\tilde{x}}_{t + 1} = {\tilde{x}}_{t} - \frac{{δ}^{2}}{2} \frac{\partial U ( {\tilde{x}}_{t} , {y}_{i} )}{\partial \tilde{x}} ,$$

which actually is a gradient descent that finds a local minimum around \hat{x} in the learned energy function U_{θ}(x, y=yᵢ).

### 5. Information Geometric Understanding

This section provides an information geometric understanding of the presented learning methodology, and shows that the presented learning methodology may be interpreted as a process of dynamic alternating projection within the framework of information geometry.

a) Embodiments of Three Families of Joint Distributions

In one or more embodiments, the presented framework comprises three trainable models, i.e., energy-based model p_{θ}(x), inference model π_{β}(z|x), and latent variable model q_{α}(x|z). They, along with the empirical data distribution p_{data}(x) and the Gaussian prior distribution q(z), define three families of joint distributions over the latent variables z and the data x showing below:
Π-distribution: Π(z,x)=p_{data}(x)π_{β}(z|x)
Q-distribution: Q(z,x)=q(z)q_{α}(x|z)
P-distribution: P(z,x)=p_{θ}(x)π_{β}(z|x)

In the context of information geometry, the above three families of distributions may be represented by three different manifolds. Each point of the manifold stands for a probability distribution with a certain parameter.

The variational MCMC teaching disclosed in the present disclosure to train both EBM and VAE integrates variational learning and energy-based learning, which is a modification of maximum likelihood estimation. The training process alternates these two learning processes, and eventually leads to maximum likelihood solutions of all the models. In the description below, each part is separately disclosed, and then integrated together for a final interpretation.

b) Embodiments of Variational Learning as Alternating Projection

Original variational learning approach, such as VAEs, is to learn {α, β} from training data p_{data}(x), whose objective function is a joint minimization min_{β} min_{α}KL(P_{θ}_{ₜ}∥Q). However, in one or more embodiments of the present learning methodology, the VAE component learns to mimic the EBM at each iteration by learning from its generated examples. Thus, given θₜ at iteration t, the VAE objective may become min_{β} min_{α}KL(P_{θ}_{ₜ}∥Q), where the subscript θₜ is added to P to indicate that the P-distribution is associated with a fixed θₜ. The following Equation reveals that KL(P_{θ}_{ₜ}∥Q) is exactly the VAE loss in Equation (10).

$$\begin{matrix}KL ( {P}_{{θ}_{t}} \vert \vert Q ) = KL ( {p}_{{θ}_{t}} ( x ) {π}_{β} ( z \vert x ) \vert \vert {q}_{α} ( x \vert z ) q ( z ) ) \\ = KL ( {p}_{{θ}_{t}} ( x ) \vert \vert {q}_{α} ( x ) ) + KL ( {π}_{β} ( z \vert x ) \vert \vert {q}_{α} ( z \vert x ) ) \\ = KL ( {ℳ}_{{θ}_{t}} {q}_{{α}_{t}} ( x ) \vert \vert {q}_{α} ( x ) ) + KL ( {π}_{β} ( z \vert x ) \vert \vert {q}_{α} ( z \vert x ) )\end{matrix} \qquad ( 14 )$$

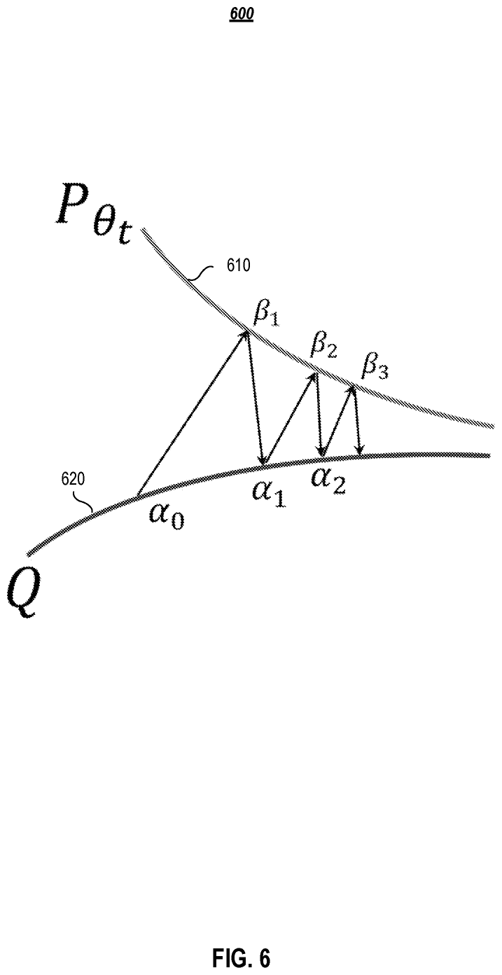

Minimizing the KL divergence between two probability distributions may be interpreted as a projection from a probability distribution to a manifold. FIG. 6 depicts variational learning interpreted as a process of alternating projection between manifolds P_{θ}_{ₜ} and Q, according to embodiments of the present disclosure. As illustrated in FIG. 6, each manifold may be visualized as a curve and the joint minimization in VAE in Equation (14) may be interpreted as alternating projection between manifolds P_{θ}_{ₜ} and Q, where π_{β} and q_{α} run toward each other and eventually converge at the intersection between manifolds P_{θ}_{ₜ} and Q. Manifold P_{θ}_{ₜ} is represented by a curve 610 and manifold Q is represented by a curve 620. Each point of the curve 620 corresponds to a certain α, while each point of the curve 610 corresponds to a certain β.

c) Embodiments of Energy-Based Learning as Manifold Shifting

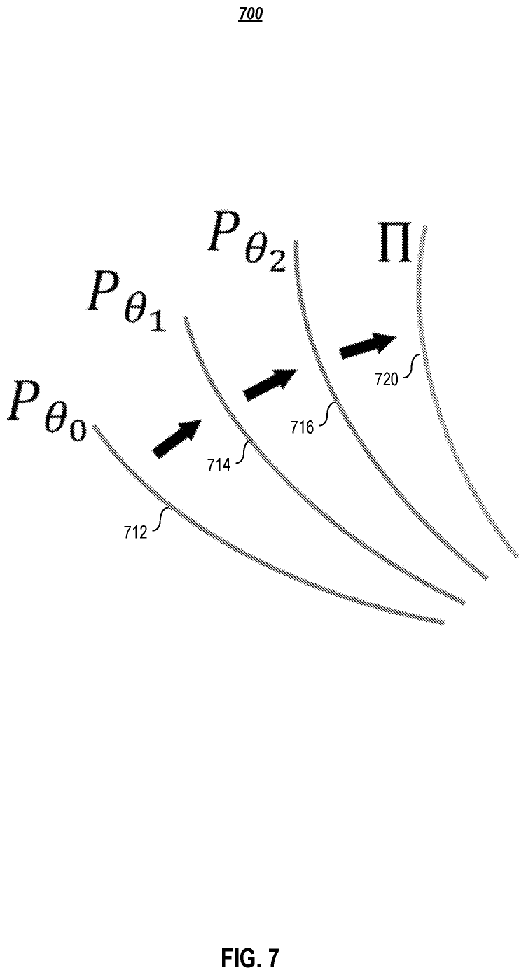

With the examples generated by the ancestral Langevin sampler, the objective function of training the EBM may be min_{θ}KL(Π∥P), i.e., min_{θ}KL(p_{data}∥P_{θ}). FIG. 7 depicts energy-based learning interpreted as a process of manifold shifting process from P_{θ}_{ₒ} to Π, according to embodiments of the present disclosure. θ₀ denotes the initial θ at time 0. Manifolds {P_{θ}_{ₜ}} are represented by curves 712, 714, and 716, while manifold Π is represented by a curve 720. As illustrated in FIG. 7, P_{θ}_{ₒ} runs toward H and seeks to match it. Each point in each curve represents a different β.

d) Embodiments of Integrating Energy-Based Learning and Variational Learning as Dynamic Alternating Projection

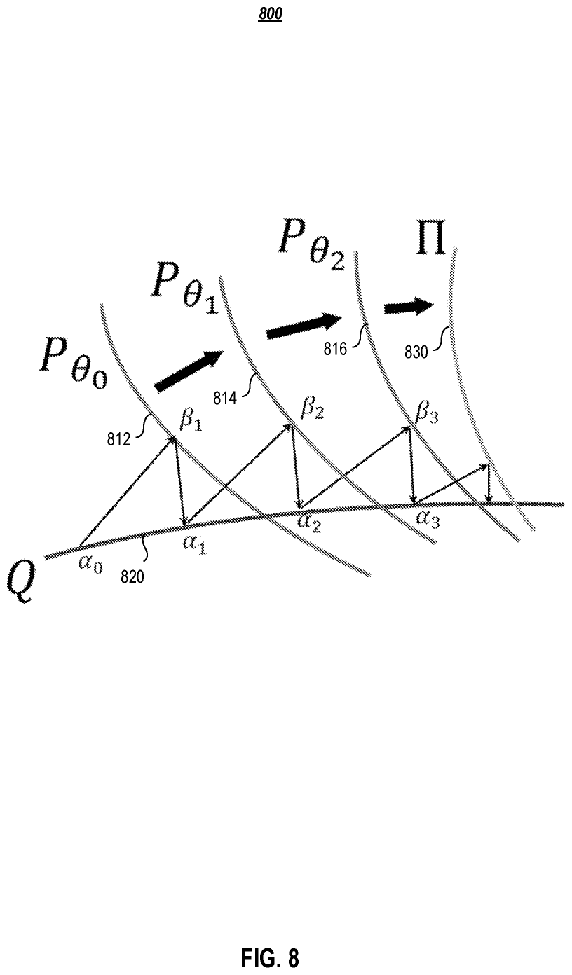

In one or more embodiments, the joint training of p_{θ}, π_{β}, and q_{α} in the presented framework integrates energy-based learning and variational learning, which may be interpreted as a dynamic alternating projection between Q and P, where Q is static but P is changeable and keeps shifting toward H. FIG. 8 graphically depicts variational MCMC teaching as dynamic alternating projection, according to embodiments of the present disclosure. Manifolds P, Q, and Π are represented by P_{θ}_{ₜ} curves 812˜816, curve 820, and curve 830, respectively. Ideally, P matches Π, i.e., P_{\hat{θ}}=Π.

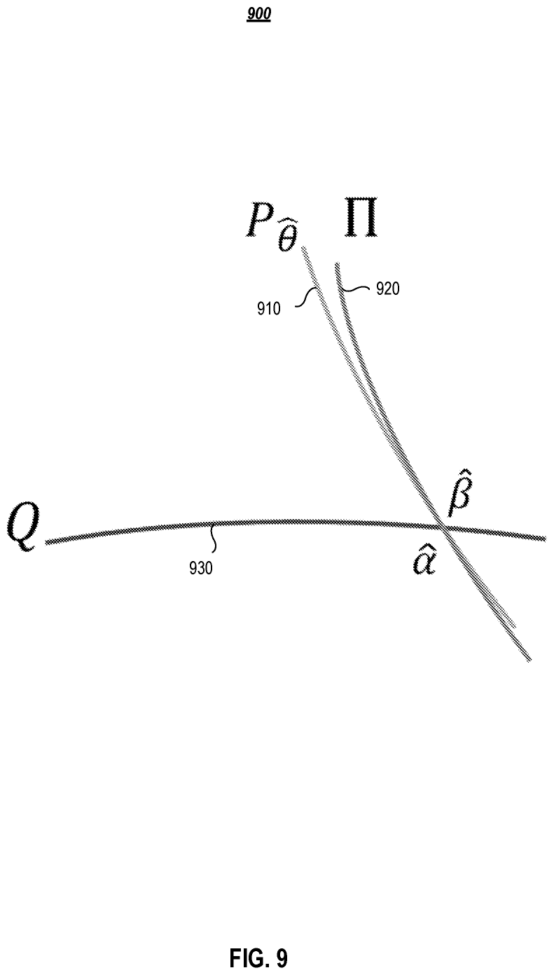

FIG. 9 graphically depicts the convergent point of the dynamic alternating projection, according to embodiments of the present disclosure. The alternating projection would converge at the intersection point among the P curve 910, the Q curve 930, and the Π curve 920, where min_{α} min_{β}KL(Π∥Q), the objective of the original VAE, is obtained. In other words, Q and P get close to each other, while P seeks to get close to Π. In the end, q_{α} chases p_{θ} towards p_{data}. As shown in FIG. 9, triplet (\hat{θ}, \hat{α}, \hat{β}) is the Nash equilibrium (optimal solution) of the learning methodology.

e) Comparison with Related Models

This subsection highlights the difference between the presented method and some closely related models, such as triangle divergence and cooperative network. The presented model optimizes:

$${min}_{θ , α , β} KL ( \prod \vert \vert Q ) + KL ( P \vert \vert Q )$$

or equivalently,

$${min}_{θ , α , β} KL ( {p}_{data} \vert \vert {p}_{θ} ) + KL ( {p}_{θ} \vert \vert {q}_{α} ) + KL ( {π}_{β} ( z \vert x ) \vert \vert {q}_{α} ( z \vert x ) )$$

The above optimization is different from the triangle divergence framework, which also trains energy-based model, inference model, and latent variable model together but optimizes the following different objective:

$${min}_{θ , α , β} KL ( \prod \vert \vert Q ) + KL ( P \vert \vert Q ) - KL ( \prod \vert \vert P )$$

The cooperative learning framework (CoopNets) jointly trains the energy-based model p_{θ}(x) and the latent variable model q_{α}(x) by

$${min}_{θ , α , β} KL ( {p}_{data} \vert \vert {p}_{θ} ) + KL ( {p}_{θ} \vert \vert {q}_{α} )$$

without leaning an approximate π_{β}(z|x). Instead, CoopNets directly accesses the inference process q_{α}(z|x) by MCMC sampling.

### E. Some Experimental Results

This section presents experiments to demonstrate the effectiveness of the presented method to train EBMs with (a) competitive synthesis for images, (b) high expressiveness of the learned latent variable model, and (c) strong performance in image completion.

It shall be noted that these experiments and results are provided by way of illustration and were performed under specific conditions using a specific embodiment or embodiments; accordingly, neither these experiments nor their results shall be used to limit the scope of the disclosure of the current patent document.

### 1. Image Generation

Embodiments of the presented framework are proven to be effective to represent a probability density of images. It is demonstrated the learned model may generate realistic image patterns. The presented model was learned from various images without class labels. The qualities of images generated by the ancestral Langevin sampling are quantitatively evaluated via Fréchet inception distance (FID) score and Inception score in Table 1 and Table 2. The experiments validate the effectiveness of the presented model. All networks in the presented model are designed with simple convolution and rectified linear unit (ReLU) layers, and only 15 or 50 Langevin steps are used. The Langevin step size δ=0.002. The number of latent dimensions d is set as d=200.

TABLE 1
Comparison with baseline models with respect to FID score (l = 50).

| Model | FID |
|---|---|
| Generative Latent Optimization (GLO) | 49.60 |
| Conditional Generative Flow (CGLOW) | 29.64 |
| Conditional Adversarial Generative Flow (CAGLOW) | 26.34 |
| Auto-Encoding Variational Bayes (VAE) | 21.85 |
| Deep Directed Generative Models (DDGM) | 30.87 |
| Boundary Equilibrium Generative Adversarial Networks | 13.54 |
| (BEGAN) | |
| Energy-Based Generative Adversarial Networks (EBGAN) | 11.10 |
| Divergence Triangle | 6.77 |
| Cooperative Learning Framework (CoopNets) | 9.70 |
| Presented Model | 8.95 |

Experiments are also implemented to check whether the latent variable model q_{α}(z|x) learns a meaningful latent space z in this learning scheme by demonstrating interpolation between generated examples in the latent space. Each row of transition is a sequence of g_{α}(z_{η}) with interpolated z_{η}=ηzₗ+\sqrt{1η²}zᵣ, where η∈[0,1], zₗ and zᵣ are the latent variables of the examples at the left and right ends, respectively. The transitions appear smooth, which means that the latent variable model learns a meaningful image embedding.

TABLE 2
Comparison of Inception scores (l = 15)

| Model | IS |
|---|---|
| PixelCNN | 4.6 |
| Pixel Implicit Quantile Networks (PixelIQN) | 5.29 |
| Energy-Based Models (EBM) | 6.02 |
| Deep Convolutional Generative Adversarial Network | 6.4 |
| (DCGAN) | |
| Wasserstein GAN + gradient penalty (WGAN-GP) | 6.5 |
| CoopNets | 6.55 |
| Presented Model | 6.65 |

Once the model is leaned, the gap between p_{θ} and q_{α} is also checked by visualizing the Langevin dynamics initialized by a sample from the latent variable model. It is found that even though the Langevin dynamics may still improve the initial example, but their difference is quite small, which is in fact a good phenomenon revealing that the latent variable model has caught up with the EBM, which runs toward the data distribution. That is, q_{α} becomes the stationary distribution of p_{θ}, or KL( [symbol] _{\hat{θ}}q_{\hat{α}}(x)∥q_{\hat{α}}(x))→0.

### 2. Image Completion

The presented conditional model is applied for image completion, where a stochastic mapping is learned from a centrally masked image to the original one. The centrally masked image is of the size 256×256 pixels, centrally overlaid with a mask of the size 128×128 pixels. The conditional energy function in p_{θ}(x|y) takes the concatenation of the masked image y and the original image x as input and consists of three convolutional layers and one fully connected layer. For the conditional latent variable model q_{α}(x|y, z), a U-Net is used with the latent vector z concatenated with its bottleneck. Latent dimension d is set as d=8. The conditional encoder π_{β}(z|y, x) has five residual blocks and MLP layers to get the variational encoding. Embodiments of the presented model are compared to baselines including pix2pix (Image-to-image translation with conditional adversarial nets), cVAE-GAN (Conditional Variational Autoencoder GAN), cVAE-GAN++ (cVAE-GAN with an additional loss [symbol] _{GAN}(G, D)), Bicycle-GAN (a hybrid model combining cVAE-GAN and cLR-GAN), and cCoopNets (a conditional version of CoopNets) on various datasets in Table 3. The recovery performance is measured by the peak signal-to-noise ratio (PSNR) and Structural SIMilarity (SSIM) between the recovered image and the original image. It may be seen from Table 3 that the presented method outperforms the baselines.

TABLE 3
Comparison with baselines for image completion

| | Dataset 1 | | Dataset 2 | |
|---|---|---|---|---|
| Model | PSNR | SSIM | PSNR | SSIM |
| pix2pix | 19.34 | 0.74 | 15.17 | 0.75 |
| cVAE-GAN | 19.43 | 0.68 | 16.12 | 0.72 |
| cVAE-GAN++ | 19.14 | 0.64 | 16.03 | 0.69 |
| BicycleGAN | 19.07 | 0.64 | 16.00 | 0.68 |
| CoopNets | 20.47 | 0.77 | 21.17 | 0.79 |
| Ours | 21.62 | 0.78 | 22.61 | 0.79 |

### 3. Model Analysis

The presented framework involves three different components, each of which has some key hyper-parameters that might affect the behavior of the whole training process. Some factors that may potentially influence the performance of the presented framework are evaluated. The results are reported after 1,000 epochs of training.

Number of Langevin steps and Langevin step size Effects of the number of Langevin steps and their step size on the synthesis performance are evaluated. Table 4 shows the influence of varying the number of Langevin steps and Langevin step size, respectively. As the number of Langevin steps increases and the step size decreases, improved quality of image synthesis in terms of inception score is observed.

TABLE 4
Influence of number of MCMC steps l and MCMC step size δ, with the
number of latent dimensions d = 200, and variational loss penalty γ = 2.

| IS ↑ | l = 5 | l = 8 | l = 15 | l = 30 | l = 60 |
|---|---|---|---|---|---|
| δ = 0.001 | 3.606 | 4.333 | 6.072 | 6.038 | 6.143 |
| δ = 0.002 | 3.847 | 5.568 | 6.075 | 5.989 | 5.882 |
| δ = 0.004 | 4.799 | 5.286 | 5.979 | 5.907 | 5.933 |
| δ = 0.008 | 5.146 | 5.164 | 5.835 | 4.574 | 3.482 |

Number of dimensions of the latent space Effects of the number of dimensions of the latent space on the ancestral Langevin sampling process in training the energy-based model are also studied. Table 5 displays the inception scores as a function of the number of latent dimensions of q_{α}(x). l=10, δ=0.002, and γ=2.

TABLE 5
Influence of the number of latent dimension d

| d | 1200 | 600 | 200 | 100 | 50 | 10 |
|---|---|---|---|---|---|---|
| IS ↑ | 6.017 | 6.213 | 6.159 | 6.085 | 6.027 | 5.973 |

Variational loss penalty The penalty weight γ of the term of KL-divergence between the inference model and the posterior distribution in Equation (9) plays an important role in adjusting the tradeoff between having low auto-encoding reconstruction loss and having good approximation of the posterior distribution. Table 6 displays the inception scores of varying γ, with d=200, l=10, and δ=0.002. The optimal choice of γ in the presented model is set roughly as 2.

TABLE 6
Influence of the variational loss penalty γ

| γ | 0.05 | 0.5 | 1 | 2 | 8 | 10 |
|---|---|---|---|---|---|---|
| IS ↑ | 5.106 | 5.663 | 5.905 | 6.159 | 5.890 | 4.693 |

### F. Some Conclusions

The present patent document discloses embodiments to learn an EBM with a VAE as an amortized sampler for probability density estimation. In particular, embodiments of variational MCMC teaching methodology are presented to jointly train the EBM and VAE together. In the joint training framework, the latent variable model in the VAE and the Langevin dynamics derived from the EBM learn to collaborate to form an efficient sampler, which is essential to provide Monte Carlo samples to train both the EBM and the VAE. Such a method naturally unifies the maximum likelihood estimation, variational learning, and MCMC teaching in a single computational framework, and may be interpreted as a dynamic alternating projection within the framework of information geometry. The present framework may be appealing as it combines the representational flexibility and ability of the EBM and the computational tractability and efficiency of the VAE. Experiments show that embodiments of the presented framework may be effective in image generation, and its conditional generalization may be useful for computer vision applications, such as image completion.

### G. Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid-state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

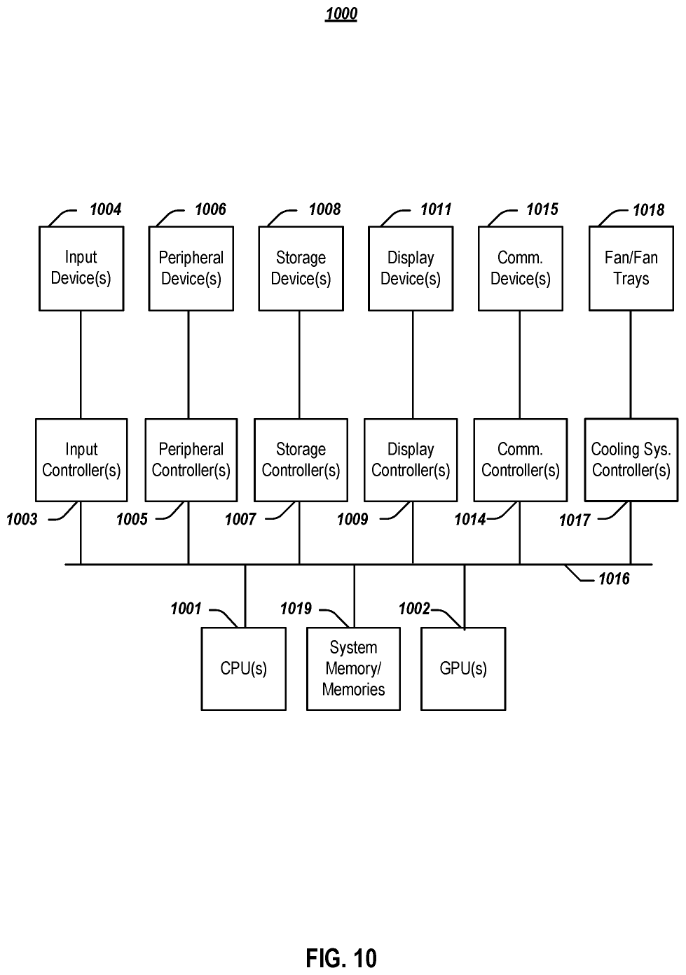

FIG. 10 depicts a simplified block diagram of an information handling system (or computing system), according to embodiments of the present disclosure. It will be understood that the functionalities shown for system 1000 may operate to support various embodiments of a computing system—although it shall be understood that a computing system may be differently configured and include different components, including having fewer or more components as depicted in FIG. 10.

As illustrated in FIG. 10, the computing system 1000 includes one or more CPUs 1001 that provide computing resources and control the computer. CPU 1001 may be implemented with a microprocessor or the like, and may also include one or more graphics processing units (GPU) 1002 and/or a floating-point coprocessor for mathematical computations. In one or more embodiments, one or more GPUs 1002 may be incorporated within the display controller 1009, such as part of a graphics card or cards. Thy system 1000 may also include a system memory 1019, which may comprise RAM, ROM, or both.

A number of controllers and peripheral devices may also be provided, as shown in FIG. 10. An input controller 1003 represents an interface to various input device(s) 1004. The computing system 1000 may also include a storage controller 1007 for interfacing with one or more storage devices 1008 each of which includes a storage medium such as magnetic tape or disk, or an optical medium that might be used to record programs of instructions for operating systems, utilities, and applications, which may include embodiments of programs that implement various aspects of the present disclosure. Storage device(s) 1008 may also be used to store processed data or data to be processed in accordance with the disclosure. The system 1000 may also include a display controller 1009 for providing an interface to a display device 1011, which may be a cathode ray tube (CRT) display, a thin film transistor (TFT) display, organic light-emitting diode, electroluminescent panel, plasma panel, or any other type of display. The computing system 1000 may also include one or more peripheral controllers or interfaces 1005 for one or more peripherals 1006. Examples of peripherals may include one or more printers, scanners, input devices, output devices, sensors, and the like. A communications controller 1014 may interface with one or more communication devices 1015, which enables the system 1000 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1000 comprises one or more fans or fan trays 1018 and a cooling subsystem controller or controllers 1017 that monitors thermal temperature(s) of the system 1000 (or components thereof) and operates the fans/fan trays 1018 to help regulate the temperature.

In the illustrated system, all major system components may connect to a bus 1016, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher-level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method to train an energy-based model (EBM) using a training dataset sampled from an unknown distribution comprising:
initializing, using a latent variable model parameterized by latent variable model parameters, one or more initial samples from a noise distribution;
implementing a finite number of steps of Langevin revision to revise the one or more initial samples into one or more revised samples;
using the one or more revised samples as Markov chain Monte Carlo (MCMC) examples from an EBM distribution parameterized by EBM parameters to obtain a gradient of a Kullback-Leibler (KL) divergence between the EBM distribution and the unknown distribution with respect to the EBM parameters;
updating, via an optimization process, the EBM parameters using the gradient of the KL divergence; and
forming an inference network parameterized by inference network parameters and the latent variable model into a variational auto-encoder (VAE) to jointly update the inference network parameters and the latent variable model parameters by minimizing a VAE objective function, the one or more revised samples are used as training data to train the VAE.

2. The computer-implemented method of claim 1 wherein the method is iteratively implemented until a stop condition is met.

3. The computer-implemented method of claim 2 wherein the stop condition is a predetermined iteration number or a convergence of the EBM parameters, the inference network parameters, and the latent variable model parameters.

4. The computer-implemented method of claim 1 wherein the noise distribution is a Gaussian distribution.

5. The computer-implemented method of claim 1 wherein the KL divergence is approximated as a difference between an average gradient of an EBM energy function of the training dataset with respect to the EBM parameters and an average gradient of the EBM energy function of the revised samples with respect to the EBM parameters.

6. The computer-implemented method of claim 1 wherein the optimization process for updating the EBM parameters involves minimizing a modified contrastive divergence, which is a difference between the KL divergence between the EBM distribution and the unknown distribution and a KL divergence between a marginal distribution and the EBM distribution.

7. The computer-implemented method of claim 1 wherein the inference network functions as an encoder and the latent variable model functions as a decoder in the VAE.

8. The computer-implemented method of claim 1 wherein the VAE objective function is a KL-divergence between tractable joint distributions.

9. A computer-implemented method for conditional predictive learning comprising:
generating, by a conditional latent variable model, an initial output by mapping an input and a vector of latent Gaussian noise, the input is sampled from an unknown data distribution;
revising the initial output using the Langevin dynamics of a conditional energy-based model (EBM), the conditional EBM represents a conditional EBM distribution;
forming the conditional latent variable model and a conditional inference network into a conditional variational auto-encoder (VAE) for joint training the parameters of both the conditional latent variable model and the conditional inference network;
using the revised output as Markov chain Monte Carlo (MCMC) examples from the conditional EBM distribution to obtain a gradient of a Kullback-Leibler (KL) divergence between the conditional EBM distribution and the unknown data distribution with respect to parameters of the conditional EBM; and
updating, by an optimization process, the parameters of the conditional EBM using the gradient of the KL divergence.

10. The computer-implemented method of claim 9 further comprising:
iterating the method until a stop condition is met; and
once the stop condition is met, generating samples conditioned on the input by following an ancestral Langevin sampling process.

11. The computer-implemented method of claim 9 wherein the conditional inference network functions as an encoder of the conditional VAE and the conditional latent variable model functions as a decoder of the conditional VAE.

12. The computer-implemented method of claim 9 wherein the input and the vector of latent Gaussian noise are mapped using a mapping function parameterized by the conditional latent variable model parameters.

13. The computer-implemented method of claim 9 further comprising:
performing a deterministic generation as prediction without sampling by
generating, by the conditional latent variable model, an initial prediction; and
refining, using the conditional EBM, initial prediction by a finite number of steps of noise-disable Langevin dynamics.

14. A non-transitory computer-readable medium or media comprising one or more sequences of instructions which, when executed by at least one processor, causes steps for training an energy-based model (EBM) using a training dataset sampled from an unknown distribution comprising:
initializing, using a latent variable model parameterized by latent variable model parameters, one or more initial samples from a noise distribution;
implementing a finite number of steps of Langevin revision to revise the one or more initial samples into one or more revised samples;
using the one or more revised samples as Markov chain Monte Carlo (MCMC) examples from an EBM distribution parameterized by EBM parameters to obtain a gradient of a Kullback-Leibler (KL) divergence between the EBM distribution and the unknown distribution with respect to the EBM parameters;
updating, via an optimization process, the EBM parameters using the gradient of the KL divergence; and
forming an inference network parameterized by inference network parameters and the latent variable model into a variational auto-encoder (VAE) to jointly update the inference network parameters and the latent variable model parameters by minimizing a VAE objective function, the one or more revised samples are used as training data to train the VAE.

15. The non-transitory computer-readable medium or media of claim 14 wherein the steps are iteratively implemented until a predetermined iteration number is met.

16. The non-transitory computer-readable medium or media of claim 14 wherein the noise distribution is a Gaussian distribution.

17. The non-transitory computer-readable medium or media of claim 14 wherein the KL divergence is approximated as a difference between an average gradient of an EBM energy function of the training dataset with respect to the EBM parameters and an average gradient of the EBM energy function of the revised samples with respect to the EBM parameters.

18. The non-transitory computer-readable medium or media of claim 14 wherein the optimization process for updating the EBM parameters involves minimizing a modified contrastive divergence, which is a difference between the KL divergence between the EBM distribution and the unknown distribution and a KL divergence between a marginal distribution and the EBM distribution.

19. The non-transitory computer-readable medium or media of claim 14 wherein the inference network functions as an encoder and the latent variable model functions as a decoder in the VAE.

20. The non-transitory computer-readable medium or media of claim 14 wherein the VAE objective function is a KL-divergence between tractable joint distributions.
